(19) United States
(12) Patent Application Publication
(10) Pub. No.: US 2003/0210862 A1
(43) Pub. Date: Nov. 13, 2003

(54) Plana holographic multiplexer/demultiplexer utilizing photonic bandgap quasi-crystals with low intrinsic loss and flat top passband

(76) Inventors: Vladimir Yankov, Washington Twp., NJ (US); Igor Ivonin, Uppsala (SE); Michael Spector, Hackensack, NJ (US); Andrei Talapov, Tenafly, NJ (US); Leonid Polonskiy, Westwood, NJ (US); Sergey Babin, Castro Valley, CA (US); Alexander Goltsov, Paramus, NJ (US); Vladimir Goloviznine, Nieuwegein (NL); Anatoli Morozov, Hightstown, NJ (US); Natalya Polonskaya, Westwood, NJ (US)

Correspondence Address: KENYON & KENYON, One Broadway, New York, NY, 10004, US

(21) Appl. No.: 10/140,857

(22) Filed: May 7, 2002

(51) Int. Cl. G02B 6/34; G02B 6/293

(52) U.S. Cl. 385/37; 385/24

(57) ABSTRACT

A MUX, DEMUX or integrated combination MUX/DEMUX utilizing a discrete dispersion device (herein referred to as “D³” device), which includes at least one input port, at least one output port and an optical planar waveguide comprising a synergetic photonic bandgap quasi-crystal (“PBQC”) for guiding and supporting optical signals in a work bandwidth. The D³ device achieves a flat-top response for each channel, high channel isolation and background noise suppression.

### CROSS REFERENCE TO RELATED APPLICATIONS

The U.S. patent application Ser. No. 09/678,052, entitled “A Holographic Multiplexer/Demultiplexer and Wavelength Exchanger”, and U.S. patent application Ser. No. 09/842,065, entitled “Planar Holographic Multiplexer/Demultiplexer,” is expressly incorporated herein by reference.

### FIELD OF THE INVENTION

The present invention relates to the field of optical communications and optical transmission systems. The present invention provides an optical multiplexer, demultiplexer, or combination thereof utilizing a discrete dispersion device and a photonic bandgap quasi-crystal architecture.

### BACKGROUND INFORMATION

As demand for bandwidth continues to grow, efficient methods for providing this bandwidth while utilizing the existing infrastructure becomes critical. While bandwidth may be increased by routing additional fiber optic cables, this solution may be less desirable because it is expensive. Thus, it is desirable to deliver additional bandwidth by more efficient use of already existing fiber optic lines.

Wavelength Division Multiplexing (“WDM”) is one of the most efficient approaches to increase the bandwidth of a communication line. In WDM, multiple messages from a large number of information sources in one location are transmitted to a large number of users at another location using multiple light wavelengths. Each of the individual streams of information functions as a separate channel. Each channel is assigned a particular wavelength.

WDM requires multiplexing the channels to form a composite signal, which is then transmitted over a single transmission line, with provision at the receiver for demultiplexing of the composite signal into the individual channels. A primary advantage of multiplexing is a reduction of the number of transmission lines, because multiple channels may be transmitted over a single transmission line. Although multiplexing and demultiplexing add some components to the communication system, overall they reduce infrastructure costs for a given provided bandwidth.

Optical multiplexers (“MUXes”) and demultiplexers (“DEMUXes”) are components of WDM fiber communication systems. A MUX combines multiple signals of different wavelengths into a composite signal for transmission through a single fiber. A DEMUX separates the composite signal into the individual wavelength signals. Generally, a DEMUX requires a more elaborate design than a MUX, however, a single device may perform both MUX and DEMUX functions as a function of the direction of light propagation, using the inherent reciprocity of optical waves in dielectric media. Thus, a single device may provide a dual (reversible) functionality as both a MUX and a DEMUX device by changing the direction of light propagation through the device. Such a device is referred to as a MUX/DEMUX.

Conventional MUX/DEMUX devices perform a spectral selectivity function utilizing either diffraction or an interference phenomena. Typically these conventional devices utilize either thin film filters, fiber Bragg gratings or arrayed waveguide gratings (“AWGs”). See R. Kashyap, Fiber Bragg Gratings, Academic Press (1999); M. K. Smit, Electronic Letters, v.24, 385 (1988). While thin film filters and fiber Bragg gratings may provide a maximum channel count of 16, AWGs may provide a channel count greater than 16.

MUX/DEMUX devices may be further classified according to their architecture. The devices may be assembled from separate components, referred to as bulk design or they may be constructed as a single entity on a single planar waveguide chip, which is referred to as monolithic design or planar monolithic design. Monolithic design is preferable because the manufacturing of the devices may be automated, thereby reducing costs. In addition, with monolithic design, the device dimensions may be made significantly smaller. A further advantage of monolithic design is improved reliability, as this manufacturing method eliminates the possibility for the misalignment of components. Another important advantage of planar monolithic devices is that they may be easily integrated with other WDM components into a multifunctional optical chip.

AWGs are monolithic devices characterized by small size, high channel count, and low crosstalk between the channels at a reasonable price per channel, however, the AWG has certain undesirable properties. The AWG devices achieve spectral selectivity by a continuous dispersion of different wavelengths. Any tiny wavelength change in the input signal leads to the displacement of the focus of demultiplexed light along the direction of dispersion. Respectively, the focus moves over the input edge of the coupled output waveguide. As the waveguide tip is placed in the position providing the best coupling for the central wavelength in each channel, any displacement inside one channel bandwidth will decrease coupling efficiency and intensity of the demultiplexed output signal.

For this reason, the passband of each channel has a Gaussian shape. See K. Okamoto, Fundamentals of Optical Waveguides, Academic Press (2000). A Gaussian passband profile may be less desirable than a flat spectral response as transmitting lasers exhibit some wavelength drift inside the channel width and any non-flat-top channel profile will cause significant attenuation of the signal when the wavelength deviates slightly from the passband center. Continuous dispersion is the main reason for non-flat-top passband shapes in AWGs and other devices based on the same continuous dispersion principle.

As the bit rate of the fiber lines is increased, the spectral width of the laser radiation for each channel increases approaching the channel width. In this situation, non-flat spectral response of the MUX/DEMUX devices causes significant distortion of the signal, attenuating peripheral zones of the channel spectrum.

Some approaches to remedy the spectral profile of AWG devices have attempted to flatten the spectral response of AWGs (Okamoto). However, all of these approaches have dramatically increased the intrinsic loss for AWGs. High intrinsic loss may not be a desirable feature as it demands additional power output from transmitters and amplifiers used in fiber optic telecommunication systems.

An alternative approach, which avoids the signal distortion generated by continuous dispersion devices, is to use a discrete dispersion device, in which the focal point remains fixed even while signal energy varies among frequencies within the passband.

For example, U.S. Pat. No. 4,923,271 issued to Henry et al. (the “Henry” patent) describes an optical MUX/DEMUX comprising cascaded elliptic Bragg reflectors (gratings). All gratings are formed by a microlithography arrangement in a planar waveguide. Each grating is tuned to a definite light wavelength corresponding to one of the working channels. The gratings have one common focal point and different ellipticities, so that the location of the remaining focus may be chosen in a manner providing adequate spacing between the input and outputs. Preferably, the plurality of elliptical Bragg gratings are ordered such that the grating associated with the shortest wavelength is positioned closest to the input of the device.

The Henry device is disadvantageous in a number of respects. In particular, the Henry device is not scalable to a high channel count. The gratings are separated spatially for sequential processing of light. As the number of channels and correspondingly the number of wavelength to be processed grows, the size of the device increases, the path of light to the remote gratings grows and consequently intrinsic losses grow. Also, building large devices is difficult and expensive due to limited precision of the lithographic process and uniformity of the waveguide used for gratings.

In addition, it may be desirable to utilize microlithography for fabrication of integrated two-dimensional MUX/DEMUX devices. Although a waveguide may be constructed utilizing a photorefractive material and creating refraction index modulation by irradiation with a UV laser, this is an expensive process and mass production of the devices may be problematic.

To make such a device two-dimensional, requires addressing the problem of the intersection of different subgratings. This problem may be addressed by using a waveguide made of a photorefractive material and creating refraction index modulation by irradiation with a UV laser. In this case, the intersections will have increased depth of modulation and the subgratings will work independently. However, taking into account the current state-of-the-art of this technology, it is an expensive process and mass production of the devices may be problematic. Also, the dynamic range of the change in the refraction index is limited and will not allow for writing multiple overlaid subgratings in a linear range. In addition, direct writing with a focused laser beam demands extremely sharp focusing, of ˜0.25 microns. On the other hand, using interference patterns between two laser beams allows for writing easily only straight lines and has not been developed for more complex (sophisticated) gratings, consisting of curved lines.

### SUMMARY OF THE INVENTION

The present invention provides for a MUX, DEMUX or integrated combination MUX/DEMUX utilizing a discrete dispersion device (“D³” device), which includes at least one input port, at least one output port, and an optical planar waveguide, including a synergetic photonic bandgap quasi-crystal (“PBQC”) for guiding and supporting optical signals in a work bandwidth. The synergetic D³ device according the present invention may be advantageous in that it achieves a flat-top response for each channel, high channel isolation, and background noise suppression.

The synergetic device according to the present invention may provide better performance by utilizing a synergetic approach. Each of a plurality of binary features of the composite supergrating produces constructive interference for several channels rather than for a single channel, as it occurs in the superimposed independently written subgratings.

The PBQC includes a plurality of binary features to produce what is referred to herein as a synergetic supergrating. Each binary feature generates constructive interference on average for a plurality of wavelengths. The PBQC including the plurality of binary features is achieved through a process herein referred to as the synergetic method, a method which may allow for significantly better performance with respect to lower incoherent scattering than the method of superimposing a plurality of gratings in a two dimensional structure.

The advantages of the synergetic approach according to the present invention are achieved due to the fact a synergetic supergrating provides the same integral passband of direct linear superposition of gratings, yet a synergetic supergrating may be etched to \sqrt{N} times lower depth. This leads to N times lower incoherent loss, since the incoherent scattering is proportional to the depth squared. If superposition of rarified subgratings allows N channels until incoherent scattering loss becomes a limitation, then the synergetic supergrating allows N² channels, assuming other parameters are fixed. According to the present invention, the synergetic supergrating is generated from a mathematical superposition of elliptic subgratings, with a spatial period of approximately one-half wavelength for each channel, by a method characterized by one or more of the steps of:

(1) generation of a two-dimensional modulation function A(x,y) representing a superposition of modulation profiles of the refraction index, each modulation function corresponding to the equivalent of a subgrating. In this first step, the two-dimensional modulation function A(x,y), which resembles an interference pattern from multiple point sources at different wavelengths is determined. The function A(x,y) is a mathematical linear superposition of elliptic subgratings, wherein each of the subgratings is tuned to one of N spectral channels

(2) binarization of the two-dimensional modulation function A(x,y) generated in (1), using a threshold value and assigning 1 to all areas above the pre-determined threshold and assigning 0 to the remaining areas to generate a function B(x,y);

(3) reduction of complex shape islands in B(x,y) with value 1 to match a pre-determined standard binary feature (e.g., a combination of short segments of straight lines (dashes)) to generate a function C(x,y); and,

(4) lithographic fabrication of a planar waveguide as a function of C(x,y) by etching all binary features to a calculated depth.

The present invention further provides a method for applying an apodization function to a function representing a plurality of binary features to be written utilizing a single layer binary microlithography process. In the method according to the present invention an apodization function g(r) is determined and applied to binary features by removing a portion of the binary features such that the average density of the binary features is proportional to g(r).

The present invention further provides a method for correcting for variations in the average refraction index of a planar waveguide introduced by the process of creating a supergrating. A supergrating creates variation of the average effective refraction index, so the light wavelength within the supergrating differs from that within blank part of the planar waveguide. To avoid undesirable distortions due to this non-uniformity, it is necessary to compensate for the refraction index variation caused by patterning the planar waveguide, including variation due to apodization. In an example embodiment of the present invention, a compensation function is defined and applied.

The present invention further provides a method for correcting for the optical loss that may vary from channel to channel. This problem is referred to as “channel non-uniformity.” In the method according to the present invention, in order to increase the relative intensity of a particular channel, a corresponding coefficient aᵢ in the modulation function A(x,y) may be increased until the corresponding channel is equalized with its neighbors. Iterating a reflection simulation procedure may provide a uniform reflection with respect to all channels.

The present invention further provides a method for reducing polarization dependent loss (“PDL”). Conventional planar waveguides support the waves of two different polarizations, the “TE-mode” and the “TM-mode.” The synergetic supergratings, according to the present invention, may allow for diminishing PDL. The present invention provides for two different methods for reducing PDL. In the first method according to the present invention, materials with a small difference in the refraction indices between the core and the cladding, or special planar design may be utilized to create a planar waveguide. This waveguide may allow for little or even zero difference in the propagation parameters of the TE- and TM-modes. In an alternative method according to the present invention there are materials with significantly different values between the core and cladding refraction indices that result in highly different effective refraction indices of the TE- and TM-modes. This may allow for writing separate subgratings for the TE and TM polarizations of light. Different reflection coefficients for the TE and TM polarizations may be compensated for by varying the coefficients, a₁.

### BRIEF DESCRIPTION OF THE DRAWINGS

FIG. 1 illustrates an integrated MUX/DEMUX according to the present invention.

FIG. 2 illustrates the operation of synergetic structures for only two elliptical subgratings according to the present invention.

FIG. 3 is a flowchart depicting a method for creating a synergetic supergrating according to an example embodiment of the present invention.

FIG. 4 shows an exemplary function A(x, y).

FIG. 5 shows an exemplary function B(x, y) after conversion (8) is applied to the function shown in FIG. 4.

FIG. 6 illustrates an exemplary realization of a function C(x, y) for an 8-channel synergetic supergrating.

FIG. 7 shows the response of an exemplary DEMUX output as a function of frequency.

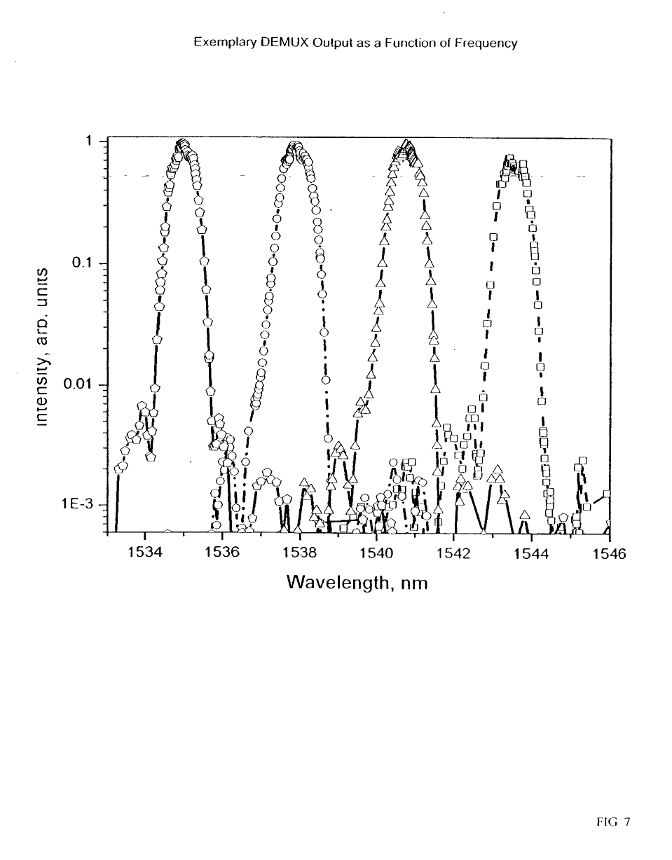

### DETAILED DESCRIPTION

A significant improvement in the performance of MUX/DEMUX devices may be achieved by using discrete dispersion devices (“D³ device”) instead of wide spread continuous dispersion ones such as AWG devices. A D³ device may be advantageous in that it achieves a flat-top response for each channel, high channel isolation, and background noise suppression.

If Bragg subgratings are utilized as resonant structures for predetermined wavelengths, discrete dispersion of the resonant wavelengths is achieved, without reflection of any non-resonant wavelength light. A D³ device is characterized by an array of focal spots, one per each channel. When the wavelength changes, a D³ device either directs the demultiplexed light into one of these focal spots, if the wavelength falls into a channel passband, or does not reflect it at all, as for intermediate wavelengths. As a result, the focal spot remains at a given output port location while the wavelength varies within the passband of the channel, dims as the wavelength leaves the passband, and re-appears at the next output port location as the wavelength approaches the passband of the next channel. Light composed of wavelengths outside the passbands propagates through the reflecting structure without reflection. Hence, a D³ device may achieve a flat-top response for each channel, high channel isolation, and background noise suppression.

A D³ device may be achieved by directly superimposing a plurality of subgratings on a planar waveguide. However, as described in detail below, although a direct superposition of subgratings does yield a working device, the performance of such a device is sub-optimal in that it does not provide maximum efficiency (flat-top passband combined with low intrinsic loss) at a considerable channel count. The reasons for this sub-optimal characteristic are described in detail below. The present invention provides for a MUX, DEMUX, or integrated combination MUX/DEMUX utilizing a D³ which is created utilizing a planar waveguide structure, herein referred to as a photonic bandgap quasi-crystal.

The present invention provides a MUX/DEMUX that avoids the sub-optimal performance of direct superposition of gratings on an optical waveguide. Instead of direct superposition of a plurality of subgratings associated with respective channels, according to the present invention, a synergetic photonic bandgap quasi-crystal including a plurality of binary features is generated such that on average a binary feature produces constructive interference for several channels rather than for a single channel. The binary features are arranged such that they exhibit quasi-periodicity. The synergetic PBQC may be utilized to perform multiplexing, demultiplexing, or any combination thereof.

According to the present invention, the synergetic PBQC is obtained utilizing a synergetic method, which includes a mathematical superposition of modulation functions followed by a binarization process. Note that this process is substantially different from a direct superposition of supergratings, because the superposition originates as a mathematical step, which effectively averages a plurality of modulation functions having varying phases. It may be shown that the expected value of a summation of sinusoidal functions having random phases is \sqrt{N}.

One method for creating a MUX/DEMUX is through direct superimposition of a plurality of subgratings onto the same area of a planar waveguide, wherein each subgrating includes a plurality of binary features such as dashed lines (i.e., instead of solid lines). Reflecting gratings may be fabricated in a medium by a regular spatial modulation of the refraction index of the medium. According to one approach, a sinusoidal modulation profile is utilized. However, according to alternative approaches, the modulation profile may be a square wave or other periodic function, provided the spatial period of modulation is the same.

Utilizing this direction superposition approach, each subgrating is resonant to a light wavelength associated with one of the channels to be demultiplexed. Each of the elliptical subgratings is positioned so that a corresponding ellipse focus coincides with an input port location, which is common for all channels. The second focus is located at an output port for the corresponding channel.

In order to achieve reflection for a particular wavelength of light propagating in a particular direction, the Bragg subgrating modulation of effective refraction index is described by the following expression:

δn(x, y)˜Sin(2πlᵢ/λᵢ+φᵢ) (1)

where

lᵢ=|\vec{r}ₒ|+|\vec{r+EEᵢ|(2)}

φᵢ is an arbitrary phase for channel number i, vector \vec{r}₀ connects the input port with an arbitrary point in the subgrating area, and \vec{r}ᵢ connects the same point with the output port for the chosen wavelength λᵢ. Note that the sinusoidal profile is merely exemplary and other profiles may be chosen. A square wave or other profile of the refraction index may also be chosen.

In the case of superposition of N subgratings the refraction index modulation is a linear superposition of all sine harmonics corresponding to N channels of the MUX/DEMUX:

$$δ n ( x , y ) ∼ {\sum }_{i = 1}^{i = N} Sin ( 2 π {d}_{i} / {λ}_{i} + {ϕ}_{i} ) . \qquad ( 3 )$$

Using the above approach, a MUX/DEMUX may be constructed utilizing a planar waveguide including a plurality of superimposed gratings in a two dimensional planar structure. Each grating may be represented as a plurality of binary features (such as dashed lines), which may be directly translated into a single layer (binary) microlithography process. Although, multi-layer lithography is applicable, it is much more expensive than single-layer lithography. Also, writing of new channels may damage previously written channels. Therefore, it may be highly desirable to write all channels in a single binary lithographic process. A binary one or zero is respectively indicated by the presence or absence of a feature at a particular spatial location, yielding a planar waveguide having a plurality of binary features.

It has been observed that rather than representing each subgrating with a continuum of possible values related to the modulation index at each spatial location, dashed lines representing a binary representation may be used. In addition, some of the lines may be removed without changing selective properties of the grating.

According to one approach, each subgrating is replaced by a rarified binary subgrating, and all of the rarefied binary subgratings are superimposed on a planar waveguide such that each channel operates independently of the others. However, if a single-layer binary microlithography process is used, the intersection of different subgrating lines in two dimensions becomes problematic, as they may be reproduced in a binary structure. In an example embodiment of the present invention, this problem may be solved by utilizing the following approach: if one binary feature such as a dash intersects another binary feature belonging to another channel, the intersection is avoided by omitting one of the intersecting dashes. The idea of overlaying the dashed rarified subgratings is based on the following property of diffraction gratings and holograms: even with substantially all of the subgratings removed they may work in the same manner as a whole grating (hologram). The idea behind this is that random removal of small parts of any regular grating makes its Fourier spectrum weaker, but all harmonics are the same. Random removal creates random noise, but it is very weak.

Although the construction of a MUX/DEMUX device utilizing an approach involving the superposition of a plurality of elliptical gratings utilizing a binary representation produces desirable results, it is not the optimal approach for providing maximum efficiency (flat-top passband combined with low intrinsic loss) at a considerable channel count. This sub-optimal characteristic is due to the fact that a dashed line (binary) subgrating has lower reflection compared to a solid one proportional to the fraction of line segments remaining. This decrease may be quantified with a fill-factor F, which is the ratio of the total lengths of dashed and solid lines:

$$F = \frac{{\sum }_{j}^{} {d}_{j}}{{\sum }_{j}^{} {D}_{j}} , \qquad ( 4 )$$

where dⱼ is the length of a dash and Dⱼ is the length of a solid line. In order to avoid multiple intersections in the case of N overlaid dashed subgratings, the following condition must be satisfied:

FN <<1 (5)

Thus, for increasing channel count F should decrease reciprocally to N:

F∝1/N (6)

Since the reflection coefficient is proportional to F, it also decreases as 1/N.

Thus, using a dashed subgrating structure, the reflection from each subgrating provides reflection proportionally to a solid subgrating in the ratio of 1/N. To compensate for this undesirable effect, the dashed subgrating structure length may be increased proportionally to N, however at the expense of producing a larger and more cumbersome device. Also, longer subgratings result in narrower passbands for each channel. An alternative method is to increase the depth of grooves for a dashed subgrating as this produces greater reflection from each groove. However, this method also has limitations, namely a dramatic increase of light scattering in the direction perpendicular to the plane of the waveguide.

The present invention provides a MUX/DEMUX, including multiple overlaid elliptical Bragg subgratings fabricated on a surface or inside of a planar optical waveguide. Each subgrating is resonant to a light wavelength associated with one of the channels to be demultiplexed. The subgratings are positioned so that one ellipse focus coincides with the input port location, which is common for all channels. The second focus is located at the output port for the corresponding channel. For optimal performance, the supergratings are constructed in a synergetic manner so that each element of a composed supergrating produces constructive interference for several channels rather than for a single channel, as it occurs in an approach where the superimposed dashed subgratings are written independently. The superposition of the elliptical subgratings in two-dimensional space may be represented by expressions (1)-(3).

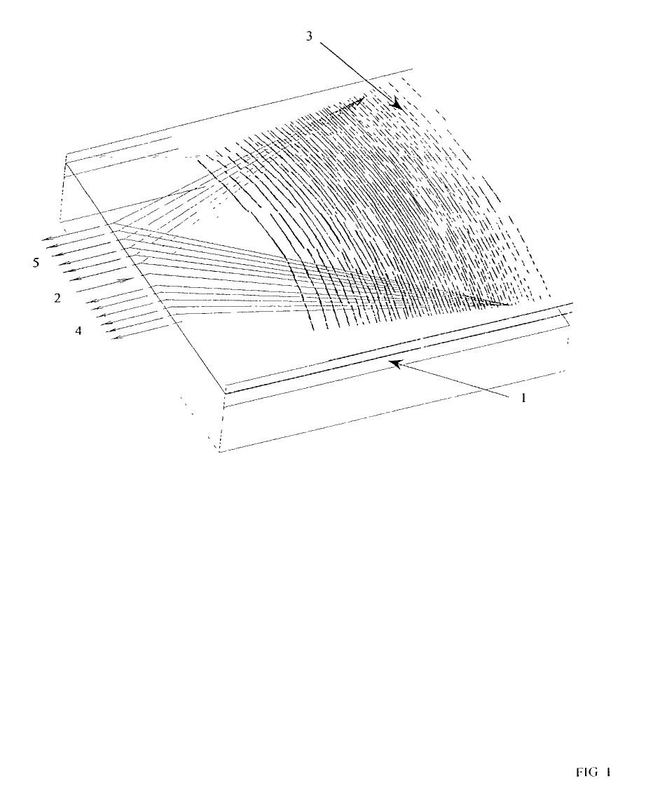

FIG. 1 illustrates an integrated MUX/DEMUX according to the present invention. Referring to FIG. 1, a planar waveguide 1 includes three flat layers of transparent optical materials, each associated with different refraction indices. The indices are chosen so that one of them, referred to herein as the core, is surrounded by other layers, referred to as claddings, which have lower refraction indices than the core. This provides a low-loss guiding of the lightwaves inside the core. According to the example embodiment shown in FIG. 1, an input light signal comprising multiple wavelengths to be demultiplexed enters through the input port 2 from a fiber or other structure, such as a ridge waveguide. The ridge waveguide delivers the light beam from the coupling point to the focus point on the input port and provides the desirable aperture of the diverging light beam. The signal then propagates within a sector determined by the angular aperture of the input port. One or more layers of the waveguide 1 are written, with multiple dashes acting as N elliptical reflecting Bragg subgratings, where N is the number of channels to be demultiplexed. The subgratings are combined into a supergrating 3, which works as a thick hologram, directing demultiplexed light wavelengths to corresponding output ports 4, 5.

In order to overcome the problems noted above wherein subgratings are simply superimposed on a waveguide and each binary feature operates upon a single wavelength, according to the present invention, the waveguide is written with features that are synergetic. That is, each feature generates constructive interference for more than one wavelength.

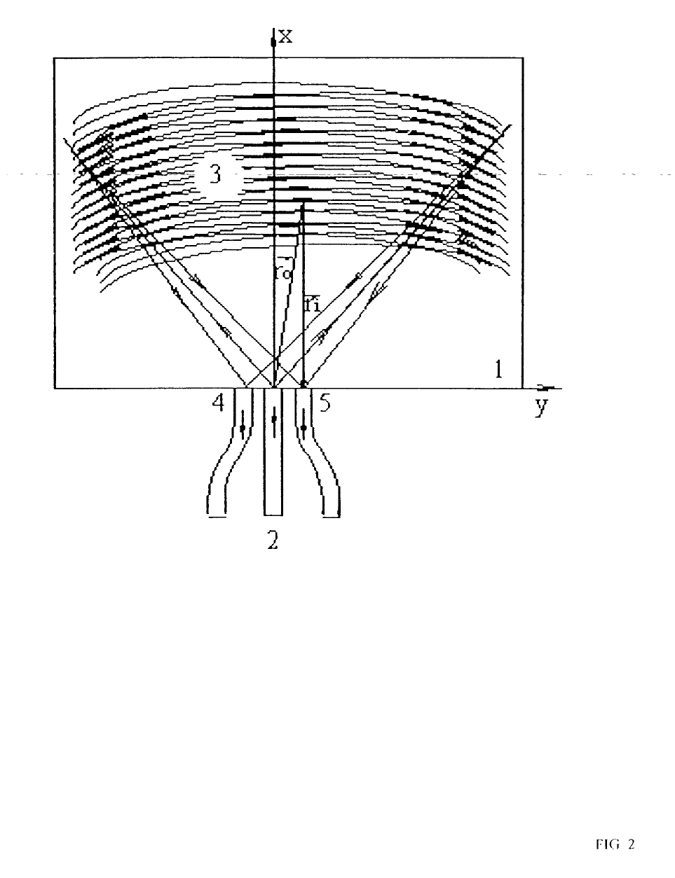

FIG. 2 illustrates the operation of synergetic structures for only two elliptical subgratings according to the present invention. According to this example, the binary features are placed at the intersections of the two elliptic subgratings such that each binary feature is operative with respect to both subgratings and the resulting supergrating demultiplexes light into the two output ports. This example illustrates the power of the synergetic approach: each binary feature is operative for more than one channel, and the synergetic supergrating becomes more efficient than a combination of independent dashed Bragg subgratings.

According to an example embodiment of the present invention, in a general case of N subgratings combined into a supergrating it may be desirable to place the binary features correctly for about \sqrt{N} channels. Such kind of synergetic supergrating is quite suitable for lithographic fabrication and mass production.

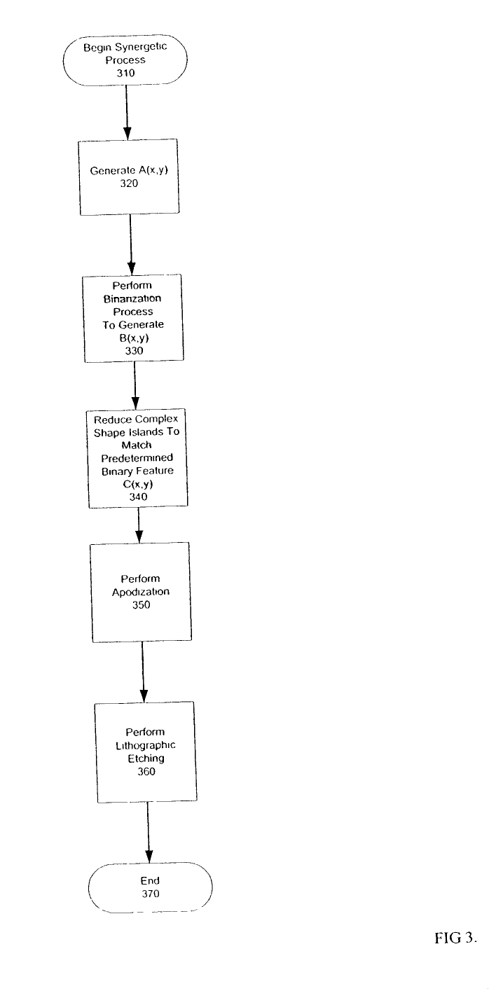

FIG. 3 is a flowchart depicting a method for creating a synergetic supergrating according to an example embodiment of the present invention.

In step 1, a two-dimensional function A(x,y), which resembles an interference pattern from multiple point sources at different wavelengths is determined. A supergrating from N elliptic Bragg subgratings is generated, wherein each of the subgratings is tuned to one of N spectral channels. In an example embodiment of the present invention, the two-dimensional profile of the refraction index is as follows:

$$A ( x , y ) ∼ {\sum }_{i = 1}^{i = N} {a}_{i} Sin ( 2 π ( 1 + f ( x , y ) ) l / {λ}_{i} + {ϕ}_{i} ) , \qquad ( 7 )$$

i=N

where l=|\vec{r}ₒ|+|\vec{r}ᵢ|, aᵢ is a weighting coefficient for the subgrating corresponding to channel number i, φᵢ is a phase for channel number i, \vec{r}₀ connects the input port with an point in the subgrating area, \vec{r}ᵢ connects the same point with the output port for the chosen wavelength λᵢ as shown in FIG. 2, and ƒ(x, y) is a function compensating for the variation of average effective refraction index, which will be discussed later. In a zero approximation, the function ƒ(x, y) may be replaced by 0.

Note that the A(x,y) function differs from holographic fringes in the absence of factor 1/r in the amplitudes, because that factor deteriorates performance. It is important to note that A(x,y) includes a number of free parameters that may be utilized to adjust the performance of the MUX/DEMUX. The role of these parameters will become evident as the present invention is further described. However, in general, the φᵢ parameters are typically chosen randomly, which produces a synergetic result that each binary feature operates on \sqrt{N} channels. In theory, these phases φᵢ could be adjusted to increase the reflection coefficients. The aᵢ parameters may be adjusted to increase the amplitudes of individual channels that may be weaker than other channels. Additionally, the aᵢ parameters determine the bandwidth of individual channels as described in detail below. Finally, the aᵢ parameters may be utilized to adjust for polarization dispersion loss (“PDL”) effects as described below.

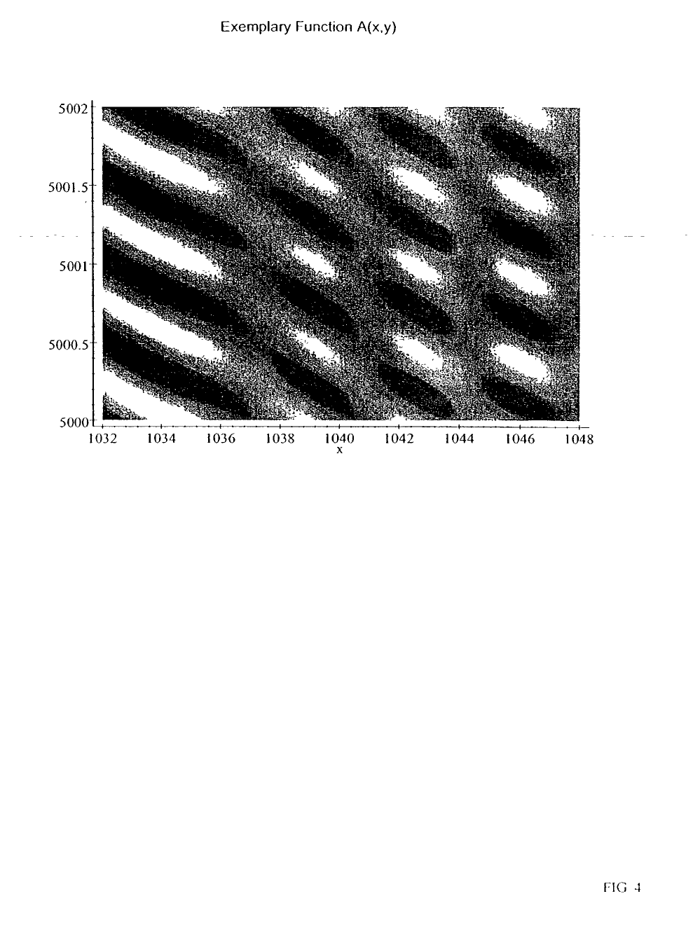

FIG. 4 shows an exemplary function A(x, y). An exemplary complex pattern, such as that shown in FIG. 4, would be difficult to fabricate using lithography in large part due to the 3-dimensional relief. Therefore, it needs to be simplified. Note that after overlaying multiple elliptical subgratings, it is difficult to distinguish any elliptical structures.

In an example embodiment of the present invention, in order to simplify the shape of A(x, y) and make its fabrication feasible, A(x, y) is converted into a binary function B(x, y). According to an example embodiment of the present invention, a binarization process is accomplished according to the following rule:

B(x, y)=1, if A(x, y)>α and (8)

B(x, y)=0 otherwise, where α is a threshold parameter.

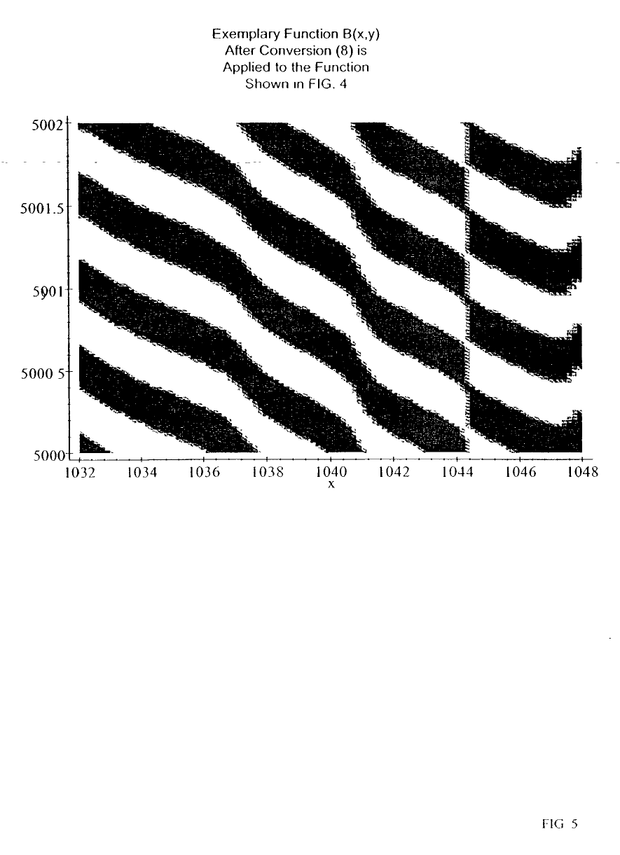

FIG. 5 shows an example of conversion (8) applied to the function shown in FIG. 4. Even after binarization, B(x, y) is still too complex for lithographic writing. A complex two-dimensional contour as shown in the example embodiment of the present invention shown in FIG. 5 is difficult to fabricate. According to an example embodiment of the present invention, a simplification of B(x,y) is achieved by approximating B(x,y) with a function C(x, y) which includes dashes of some predetermined width, length, and orientation at the slab's surface. A standard feature is chosen, such as a dashed line, and the approximation function C(x,y) attempts to match this standard function to local features in the B(x,y) function. In an example embodiment of the present invention, the matching process is achieved utilizing a least squares algorithm.

For example, if dashed binary features are employed, to maximize the reflection it is necessary to select the width of a dash to be equal to close to ¼ of the light wavelength propagating through the device. It is also necessary to ensure that the individual dashes do not touch one another. With these conditions observed, the two-dimensional relief described by B(x,y) is approximated with multiple individual dashes, the location and orientation of which is determined by finding the best fit to B(x,y). The best fit may be found by several conventional methods, for example, the mean square difference between B(x,y) and C(x,y) may be minimized by the least squares method. Another possible method is to substitute B(x,y) by a dash having the same center of gravity and the same surface and then to rotate the dash to reach maximum overlapping of the features. In an example embodiment of the present invention, B(x,y) was approximated by square pixels with sides of 0.05 of lambda, then dashes with widths of 0.25 of lambda were placed to cover as much pixel centers as possible.

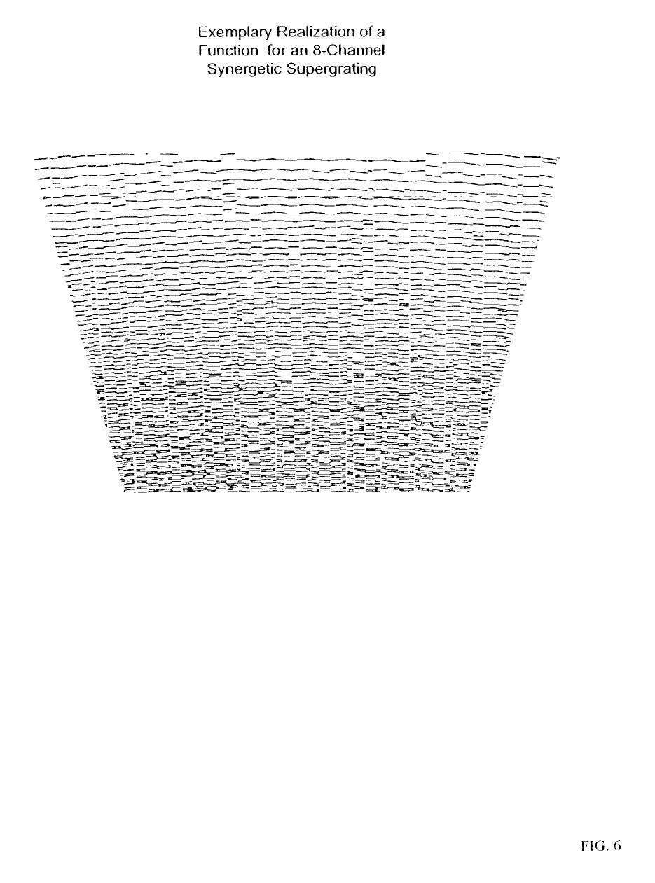

FIG. 6 illustrates an exemplary realization of a function C(x, y) for an 8-channel synergetic supergrating.

It is important to note that the method for creating synergetic structures in accordance with the present invention differs fundamentally from a method of simply superimposing binary structures. The design rules and performance of the synergetic structures achieved with the present invention provide significant performance benefits over simple superposition of gratings.

For example, comparing parameters of a simple superposition and a synergetic supergrating, having the same number of channels, N, and the same etching depth, length, and fraction of surface etched (about 50%), the performance benefits of the synergetic method become apparent.

In the case of superposed rarified subgratings, each channel works independently. However, using the synergetic structures as described herein, each feature produces constructive interference for \sqrt{N} channels. This may be seen by noting that while the function A(x, y) is not totally random, the average absolute value of A(x,y) scales as \sqrt{N}. As a result, B(x, y) which is generated from A(x,y) produces constructive interference for about \sqrt{N} channels. Since the passband of a Bragg filter is proportional to the number of dashes being in resonance with a particular channel (Charles H. Henry et al., Journal of Lightwave Technology, Vol. 8, No. 5, 1990), the passband is proportional to \sqrt{N}. As a consequence, the synergetic supergratings has \sqrt{N} times wider integral passband, W_{syn}, than that of the simple superposition of rarified subgratings, Wₛᵤₚ:

W_{syn}=\sqrt{N}Wₛᵤₚ (9)

This advantage may be transformed into lower incoherent scattering, because for obtaining the same integral passband the synergetic supergrating may be etched to \sqrt{N} times lower depth. This leads to N times lower incoherent loss, since the incoherent scattering is proportional to the depth squared. This advantage may also be seen by noting that if the superposition of rarified subgratings allows N channels until incoherent scattering loss becomes a limitation, then the synergetic supergrating allows N² channels.

Another description of a synergetic PBQC is to present it as a distortion of a simple crystal structure. A simple crystal structure has a simple bandgap for many directions if the potential (the depth of etching in our case) is small. If the periodical order is changed so that N periods will appear and every feature on average creates constructive interference for \sqrt{N} periods, then the integral bandgap is:

$${I}_{B} = \sum Δ f \approx N \frac{1}{\sqrt{N}} = \sqrt{N} , \qquad ( 10 )$$

because the sum of N subgratings may be estimated by the following expression:

$${\sum }_{i = 1}^{N} \vert cos ( {k}_{i} {l}_{i} + {ϕ}_{i} ) \vert = α \sqrt{N} . \qquad ( 11 )$$

An alternative manner to see the increase in the integral bandwidth as the result of splitting one large bandgap to N small ones is to use Parseval's theorem.

$$If {\sum }_{i = 1}^{N} {a}_{i}^{2} = 1 then {a}_{i} \approx \frac{1}{\sqrt{N}} and {I}_{B} \approx {a}_{i} N \approx \sqrt{N} \qquad ( 12 )$$

In the next step, an apodization process is applied. Due to light reflection from front and back ends of the gratings the Bragg gratings have strong side lobes. The side lobes may be reduced with the help of smoothing (apodization) of the back and front ends. Usually the grating apodization implies the variation of its refraction index modulation depth according to some apodizing function g(r), where r is the distance to the input point. In an example embodiment of the present invention, the following apodization function is applied:

$$g ( r ) = {cos}^{2} \{ π [ \frac{( r - {r}_{0} )}{( d - {r}_{0} )} - \frac{1}{2} ] \} for {r}_{0} < r < {r}_{0} + d \\ g ( r ) = 0 otherwise , \qquad ( 13 )$$

where d is the supergrating length, and r=r₀ and r=d correspond to the front and back ends of the supergrating, respectively. The function (13) corresponds to zero variation of refraction index everywhere but the supergrating area. Inside the supergrating the function increases smoothly from zero (no modulation) to unit (maximum modulation) in the supergrating center and then again slowly drops to zero at the end of the supergrating. Full-scale modulation occurs only in the center of the supergrating, which is surrounded with areas where the refraction index modulation depth varies from zero to maximum.

In an example embodiment of the present invention, because the present invention utilizes binary features, the apodization may be implemented by removing some supergrating binary features so that the average density of supergrating binary features is proportional to g(r). In an example embodiment of the present invention, in order to suppress fluctuation of the density, the following process is used.

A new function G(r) is defined as follows:

$$G ( r ) = {\int }_{0}^{r} g ( {r}^{′} ) ⅆ {r}^{′} . \qquad ( 14 )$$

Then, a binary feature is placed at all points r such that G(r) is an integer. Note that this process is merely exemplary and is not intended to limit the scope of the claims appended hereto. Any process may be applied such that fluctuations in the density of the features are accounted for.

In the next step, a compensation function is applied to correct for variations in the average refraction index. The supergrating creates variation of average effective refraction index, so the light wavelength within the supergrating differs from that within the blank part of the planar waveguide. To avoid undesirable distortions due to this non-uniformity, it is necessary to compensate for the refraction index variation caused by patterning the planar waveguide, including variation due to apodization by (13). In an example embodiment of the present invention, a compensation f function is defined by:

ƒ(x,y)=1+Δn/n=1+ag(r) (14)

where Δn is an averaged variation of the effective refraction index in the vicinity of a given point, a is a scaling parameter, and r is a distance to an input fiber (see below).

For a number of reasons the optical loss may vary from channel to channel. This problem is referred to as “channel non-uniformity”. The MUX/DEMUX according to the present invention provides for easy correction of this problem. In order to increase the relative intensity of channel number i the corresponding coefficient aᵢ in (7) may be increased until the corresponding channel is equalized with its neighbors. Iterating a reflection simulation procedure may provide a uniform reflection with respect to all channels.

The present invention also provides a method for reducing polarization dependent loss (“PDL”). It is conventional that planar waveguides support the waves of two different polarizations (TE-mode and TM-mode). The synergetic supergratings, according to the present invention, may allow for diminishing PDL. The effective refraction index as well as reflection coefficients depend on polarization. This dependence leads to PDL.

The present invention provides for two different methods for reducing PDL. In the first method according to the present invention, materials with a small difference in the refraction indices of the core and the cladding, or a special planar design may be utilized to create a planar waveguide with small or even zero difference in the propagation parameters of the TE- and the TM-modes. In an alternative example embodiment of the present invention, materials are used with significantly different values for the core and cladding refraction indices, resulting in highly different effective refraction indices of the TE and the TM modes. To avoid reflection of the TE modes due to gratings associated with TM modes and/or reflection of the TM modes from gratings associated with TE modes, the difference in effective refraction indices of the TE and the TM modes is made large. In an example embodiment of the present invention, the following relationship is observed:

$$\frac{{γ}_{E} - {γ}_{m}}{{γ}_{E}} > 2 \frac{Δ f}{f}$$

where γ_{E} is the effective index of refraction for the E mode and γ_{M} is the effective index of refraction of the M mode. If mutual transformation of the TE and TM modes may be neglected, the above condition may be relaxed as follows, where □f is the working spectral range of the WDM system:

$$\frac{{γ}_{E} - {γ}_{m}}{{γ}_{E}} > \frac{Δ f}{f} \qquad ( 15 )$$

This may allow for writing separate subgratings for the TE and TM polarizations of light. Different reflection coefficients for TE and TM polarizations may be compensated for by varying the coefficients, aᵢ (see (7)).

To avoid resonance with cladding modes, conditions analogous to those described above should be imposed, but the effective refraction coefficient for the TM mode should be substituted with the effective refraction coefficient for a cladding mode.

In an example embodiment of the present invention, the channel bandwidth for any channel may be adjusted by varying the coefficients aᵢ, due to the relationship:

Δƒᵢ=κaᵢ (16)

That is, there is a linear relationship between the bandwidth of a particular channel and the associated coefficient aᵢ, defined by the proportionality constant κ. Thus, in an example embodiment of the present invention, channels of any arbitrary bandwidths may be created.

What is claimed is:

1. An optical demultiplexer comprising:
at least one input port for receiving a composite signal comprising a superposition of optical signals;
a plurality of output ports, wherein each output port provides one of a plurality of demultiplexed optical signals;
an optical planar waveguide for guiding and supporting optical signals in a work bandwidth, wherein the optical planar waveguide is comprised of a photonic bandgap quasi-crystal (“PBQC”), the PBQC being synergetic and including a plurality of features, wherein each feature generates constructive interference on average for a plurality of wavelengths; and
wherein the composite signal received at the at least one input port is transmitted to the PBQC, the PBQC achieving a demultiplexing of the composite signal to generate the plurality of demultiplexed signals, each of the plurality of demultiplexed signals being transmitted to a respective output port.

2. The optical demultiplexer according to claim 1, wherein the features are created by:
determining a two-dimensional profile of refraction index function A(x,y), wherein A(x,y) represents a linear superposition of modulation functions, each modulation function corresponding to a distinct subgrating; and
applying a binarization process to A(x,y) to generate a two-dimensional binary function B(x,y).

3. The optical demultiplexer according to claim 2, wherein each modulation function exhibits an elliptical contour.

4. The optical demultiplexer according to claim 2, wherein the two-dimensional profile of refraction index is of the form:
$$A ( x , y ) ∼ {\sum }_{i = 1}^{i = N} {a}_{i} Sin ( 2 π ( 1 + f ( x , y ) ) l / {λ}_{i} + {ϕ}_{i} ) ,$$
where l=|\vec{r}ₒ|+|\vec{r}ᵢ|, aᵢ is a weighting coefficient for a subgrating corresponding to channel number i, φᵢ is a phase for channel number i, \vec{r}₀ connects the input port with a point in the subgrating area, +E,rar, rᵢ connects the same point with an output port for a chosen wavelength λᵢ, and ƒ(x, y) is a function compensating for a variation of average effective refraction index.

5. The optical demultiplexer according to claim 3, wherein the binary function B(x,y) is generated according to the relationship:
B(x, y)=1, if A(x, y)>α and
B(x, y)=0 otherwise, where α is a threshold parameter.

6. The optical demultiplexer according to claim 3, wherein the function B(x,y) is approximated with a function C(x, y), wherein C(x,y) comprises a plurality of features of predetermined width, depth, and position.

7. The optical demultiplexer according to claim 6, wherein each feature is a dash.

8. The optical demultiplexer according to claim 5, wherein an apodization process is applied to the function C(x,y), utilizing a function g(r), wherein r is a distance to an input point, such that the density of features is adjusted the extent that the average density of features at a distance r is proportional to g(r).

9. The optical demultiplexer according to claim 7, wherein the function g(r) is of the form:
$$\begin{matrix}g ( r ) = {cos}^{2} \{ π [ \frac{( r - {r}_{0} )}{( d - {r}_{0} )} - \frac{1}{2} ] \} for {r}_{0} < r < {r}_{0} + d \\ g ( r ) = 0 otherwise .\end{matrix}$$

10. The optical demultiplexer according to claim 4, wherein a compensation function ƒ(x,y) is applied to A(x,y) to correct for variation in the refraction index caused by patterning the planar waveguide, including variation due to apodization.

11. The optical demultiplexer according to claim 9, wherein the compensation function f(x,y) is of the form:
ƒ(r)=1+Δn/n=1+ag(r),
where r is a radial distance, Δn is an averaged variation of the effective refraction index in the vicinity of a given point, and a is a scaling parameter.

12. The optical demultiplexer according to claim 1, wherein polarization dependent loss (“PDL”) is reduced by constructing the optical demultiplexer utilizing materials with small differences in respective refraction indices for the core and the cladding such that a small difference in propagation parameters corresponding respectively to the TE and the TM modes is generated.

13. The optical demultiplexer according to claim 1, wherein PDL is reduced by constructing the optical demultiplexer utilizing materials with significantly different values of respective core and cladding refraction indices producing highly different effective refraction indices of TE-modes and TM-modes.

14. The optical demultiplexer according to claim 13, wherein the planar waveguide is written with separate subgratings for TE and TM polarizations of light and compensation for different reflection coefficients for TE and TM polarizations is achieved by varying the coefficients aᵢ.

15. An optical multiplexer comprising:
at least two input ports, wherein each input port receives one of a plurality of optical signals;
an output port for providing a composite signal comprising a superposition of optical signals;
an optical planar waveguide for guiding and supporting optical signals in a work bandwidth, wherein the optical planar waveguide is comprised of a photonic bandgap quasi-crystal (“PBQC”), wherein the PBQC is synergetic and includes a plurality of binary features, wherein each binary feature generates constructive interference on average for a plurality of wavelengths; and
wherein the plurality of optical signals are received at the respective input ports and transmitted to the PBQC, the PBQC achieving a multiplexing of the composite signal to generate the composite signal comprising a superposition of optical signals, the composite signal being transmitted to the output port.

16. A method for creating a planar waveguide for performing multiplexing and/or demultiplexing operations comprising the steps of:
determining a two-dimensional profile of refraction index function A(x,y), wherein A(x,y) represents a linear superposition of modulation functions, each modulation function corresponding to a distinct subgrating;
applying a binarization process to A(x,y) to generate a two-dimensional binary function B(x,y) representing a plurality of binary features;

17. The optical multiplexer according to claim 16, wherein each modulation function exhibits an elliptical contour.

18. The method according to claim 16, wherein the two-dimensional profile of refraction index is of the form:
$$A ( x , y ) ∼ {\sum }_{i = 1}^{i = N} {a}_{i} Sin ( 2 π ( 1 + f ( x , y ) ) l / {λ}_{i} + {ϕ}_{i} )$$
where l=|\vec{r}ₒ|+|\vec{r}ᵢ|, aᵢ is a weighting coefficient for a subgrating corresponding to channel number i, φᵢ is a phase for channel number i, \vec{r}₀ connects an input port with a point in the subgrating area, and \vec{r}ᵢ connects the same point with an output port for the chosen wavelength λᵢ, and ƒ(x, y)is a function compensating for the variation of average effective refraction index.

19. The method according to claim 17, wherein the binary function B(x,y) is generated according to the relationship:
B(x, y)=1, if A(x, y)>α and
B (x, y)=0 otherwise, where α is a threshold parameter.

20. The method according to claim 17, wherein the function B(x,y) is approximated with a function C(x, y), wherein C(x,y) comprises a plurality of features of predetermined width, depth, and position.

21. The planar waveguide according to claim 16, wherein each feature is a dash.

22. The planar waveguide according to claim 16, which involves lithographically etching a planar waveguide as a function of the binary function B(x,y) by etching the binary features to a calculated depth.

23. A method for performing apodization of a binary function representing a plurality of binary features within a two-dimensional structure comprising the steps of: determining an apodization function g(r); and, adjusting the density of binary structures such that an average density of binary structures at a distance r is proportional to g(r).

24. A method for reducing polarization dependent loss (“PDL”) in a waveguide comprising the steps of:
selecting a material with significantly different values of the core and cladding refraction indices such that different effective refraction indices of TE- and TM-modes are achieved;
determining a first function relating to a TE mode;
determining a second function relating to a TM mode;
writing the waveguide with separate subgratings for TE and TM polarizations of light respectively corresponding to the first and second function.

25. A planar waveguide, wherein the planar waveguide may be utilized for multiplexing and/or demultiplexing operations comprising:
a photonic bandgap quasi-crystal (“PBQC”), wherein the PBQC is synergetic and includes a plurality of binary features, wherein each binary feature generates constructive interference on average for a plurality of wavelengths

26. A method of demultiplexing comprising:
receiving a composite signal comprising a superposition of optical signals;
providing the composite signal to an optical planar waveguide, wherein the optical planar waveguide is comprised of a photonic bandgap quasi-crystal (“PBQC”), the PBQC being synergetic and including a plurality of features, wherein each feature generates constructive interference on average for a plurality of wavelengths and wherein the PBQC achieves a demultiplexing of the optical signals to generate a plurality of optical signals;
receiving each of the plurality of optical signals at a respective output port..

27. A method of multiplexing comprising:
receiving a plurality of optical signals;
providing each of the plurality of optical signals a respective input port of an optical planar waveguide, wherein the optical planar waveguide is comprised of a photonic bandgap quasi-crystal (“PBQC”), the PBQC being synergetic and including a plurality of features, wherein each feature generates constructive interference on average for a plurality of wavelengths and wherein the PBQC achieves a multiplexing of the optical signals to generate a composite signal comprising a superposition of the optical signals;
receiving the composite signal at an output port.
